(19) United States
(12) Patent Application Publication
(10) Pub. No.: US 2026/0164223 A1
(43) Pub. Date: Jun. 11, 2026

(54) SYSTEMS AND METHODS FOR EMERGENCY DETECTION AND ALERTING WITH AUTOMOTIVE VEHICLES

(71) Applicant: Torc Robotics, Inc., Blacksburg, VA (US)

(72) Inventors: Simon Schaefer, Stuttgart (DE); Carlo Elwinger, Maulbronn (DE); Janine Guenther, Leinfelden (DE)

(21) Appl. No.: 18/972,400

(22) Filed: Dec. 6, 2024

(51) Int. Cl. H04W 4/90; H04W 4/02; H04W 4/38; H04W 4/44

(52) U.S. Cl. CPC H04W 4/90; H04W 4/025; H04W 4/38; H04W 4/44

(57) ABSTRACT

An emergency alerting system for processing an emergency condition is provided. The system includes an automotive vehicle includes at least one sensor disposed on the automotive vehicle. The system further includes a vehicle emergency alerting computing device. The vehicle emergency alerting computing device is programmed to detect, using a machine learning model, an emergency condition based on sensor data of the at least one sensor, and upload sensor data associated with the emergency condition to a remote emergency alerting computing device. The system further includes a remote emergency alerting computing device positioned remotely from the automotive vehicle, the remote emergency alerting computing device programmed to receive the sensor data associated with the emergency condition, analyze the emergency condition, and initiate a response action based on the analysis.

### TECHNICAL FIELD

The field of the disclosure relates generally to automotive vehicles and, more specifically, systems and methods for detecting and alerting emergency conditions with automotive vehicles.

### BACKGROUND OF THE INVENTION

Modem vehicles are equipped with systems to automatically call emergency services in case of an accident. These systems send alerts to emergency service providers based on manual user actions or in car sensors. However, the alert system only handles emergencies involving the vehicle itself, and the accuracy and the amount of information for emergency services is limited. Accordingly, systems and methods to respond to a broader range of conditions with improved precision and adaptability are desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an emergency alerting system for processing an emergency condition is provided. The system includes an automotive vehicle including at least one sensor disposed on the automotive vehicle and a vehicle emergency alerting computing device. The vehicle emergency alerting computing device includes at least one first processor in communication with at least one first memory device. The at least one first processor is programmed to detect, using a machine learning model, an emergency condition based on sensor data of the at least one sensor, and upload sensor data associated with the emergency condition to a remote emergency alerting computing device. The remote emergency alerting computing device includes at least one second processor in communication with at least one second memory device. The remote emergency alerting computing device is positioned remotely from the automotive vehicle. The at least one second processor of the remote emergency alerting computing device is programmed to: receive the sensor data associated with the emergency condition, analyze the emergency condition, and initiate a response action based on the analysis.

In another aspect, an automotive vehicle is provided. The automotive vehicle includes at least one sensor disposed on the automotive vehicle and a vehicle emergency alerting computing device. The vehicle emergency alerting computing device includes at least one processor in communication with at least one memory device. The at least one processor is programmed to: detect, using a machine learning model, an emergency condition based on sensor data from the sensor, upload sensor data associated with the emergency condition to a remote emergency alerting computing device, and initiate a response action based on the emergency condition.

In yet another aspect, a computer-implemented method for processing an emergency condition is provided. The computer-implemented method includes receiving, by a remote emergency alerting computing device, sensor data, the sensor data associated with an emergency condition. The method further includes receiving the sensor data acquired by at least one sensor disposed on an automotive vehicle, and wherein the sensor data is acquired from a sensor disposed on an automotive vehicle. The method further includes detecting the emergency condition by a machine learning model deployed on the automotive vehicle. The method further includes analyzing the emergency condition on the remote emergency alerting computing device. The method further includes initiating a response action based on the analysis.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an automotive vehicle;

FIG. 2 is a block diagram of an automotive vehicle;

FIG. 3A is a schematic diagram of an example emergency detection and alerting system;

FIG. 3B is an embodiment of the emergency detection and alerting system shown in FIG. 3A;

FIG. 4A is a flow chart of an example method for emergency detection and alerting;

FIG. 4B is a flow chart of an example embodiment of the method shown in FIG. 4A;

FIG. 5A is a schematic diagram of a neural network model;

FIG. 5B is a schematic diagram of a neuron in the neural network model shown in FIG. 5A;

FIG. 6 is a block diagram of an example computing device;

FIG. 7 is a block diagram of an example user computer device; and

FIG. 8 is a block diagram of an example server computer device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods of emergency detection and alerting with automotive vehicles are provided. The automotive vehicle utilizes machine learning models (ML models) to detect emergency conditions from the sensor data captured by sensors on the automotive vehicle around the vehicle. The ML models are trained to extract features from the sensor data and detect conditions, such as emergency conditions, in the environment surrounding the automotive vehicle. One challenge of deploying ML models locally on automotive vehicles is the limited computing resources for training and retaining the ML model.

In at least some known methods for detecting emergency conditions, analytical methods are used, where sensor data is analyzed, and emergency conditions are determined based on analytical relationships between sensor data and emergency conditions. For example, when a fire occurs, the images from the sensor data have characteristics associated with the fire, such as unique image patterns and colors. Detecting emergency conditions using analytical mechanisms are computation intensive and presents additional challenges, including accounting for all potential scenarios of the emergency conditions and establishing accurate correlations between the sensor data and the emergency conditions.

In contrast, systems and methods described herein use a ML model for detecting emergency conditions. Using a ML model for detecting emergency conditions is advantageous in accounting for increased numbers and types of scenarios of emergency conditions without heavy computation as in analytical methods.

The conventional approach to improve emergency condition detection is to train with training data and/or retrain the ML models locally as additional emergency conditions are detected. However, it is impractical to utilize the limited computation resources on the automotive vehicle to perform the training and retraining. Training and/or retraining the ML model on the automotive vehicle may overburden the limited local computational resources. Further, training and retraining the ML models separately on each of the automotive vehicles in a fleet may lead to a divergence in ML model capability among the various automotive vehicles in the fleet and does not optimize the use of computational resources of the fleet.

In contrast, the disclosed systems and methods utilize the local ML model for emergency condition detection and upload of sensor data associated with the emergency condition to a remote emergency alerting computing device for analysis of the emergency condition. In this way, the ML model deployed on the automotive vehicle acts as a first level filter for the detection of the emergency condition while the computational resources for further analysis of the emergency condition and training/retraining of the model is performed elsewhere with relatively large computational resources. Separating the computational requirements of detection on the automotive vehicle and further analysis on the remote emergency alerting computing device reduces the computational resources required on the automotive vehicle for operation, thereby reducing potential interference of emergency detection and alerting with operation of the automotive vehicle. The machine learning model on the remote emergency computing device is trained, refined and tested before the machine learning model is deployed to an automotive vehicle, further limiting the impact to the operation of the automotive vehicle. Besides not placing a burden on the operation of the automotive vehicle, a remote emergency alerting computing device is advantageous in analyzing and alerting the emergency condition, with increased accuracy. The disclosed systems and methods allow for training data collection among the automotive vehicles in the fleet while training and retraining of the ML models onto the remote emergency computing device, thereby improving the capabilities of the ML model with increased training data from the fleet.

The remote emergency alerting computing device in the systems and methods described herein is configured to analyze uploaded sensor data corresponding to a detected emergency condition on an automotive vehicle to verify the emergency condition or determine whether the emergency condition is a non-emergency. The remote emergency alerting computing device is configured to assess the severity of the emergency condition and scale the emergency response accordingly. In the case of a verified emergency condition, the remote emergency alerting computing device may initiate a response action, such as alerting emergency services. The disclosed systems and methods decrease the time it takes to notify emergency services by delegating notification to a remote emergency alerting computing device and increase the accuracy in emergency condition notified to emergency services by eliminating, or at least substantially reducing false positives. Further, the remote emergency alerting computing device may use the uploaded sensor data to further retrain the ML models.

The retrained ML model may be updated or deployed on the fleet, thereby improving emergency detection capabilities and providing consistent capabilities across the fleet. A feedback loop is created by providing false positive emergency conditions determined by the remote emergency alerting computing device to improve the ML models. The ML models are retrained with the false positive emergency conditions, thereby improving emergency detection accuracy Further, retraining and deploying the ML models from the remote emergency alerting computing device ensures that updates and refinements to the ML models are uniformly applied to all automotive vehicles in the fleet to provide uniform emergency response functionalities. Additionally, retraining the models supports the incorporation of new emergency conditions, enabling the automotive vehicle to adjust to changing environments.

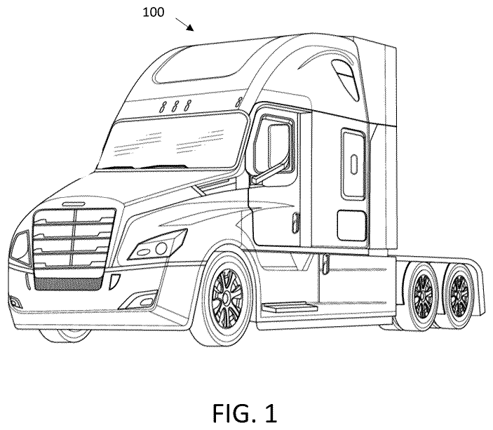

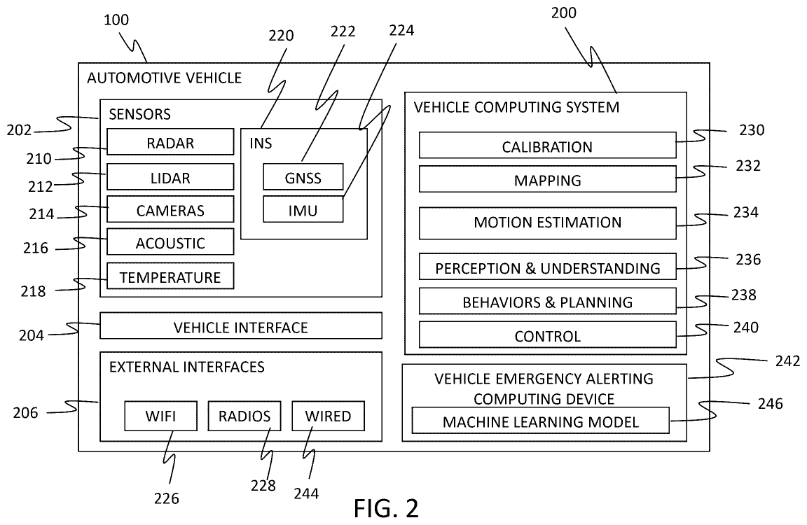

FIG. 1 is a schematic diagram of an automotive vehicle 100. FIG. 2 is a block diagram of the automotive vehicle 100 shown in FIG. 1. In the example embodiment, the automotive vehicle 100 includes a vehicle computing system 200, sensors 202, a vehicle interface 204, and external interfaces 206.

In the example embodiment, the sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. The sensors 202 generate respective output signals based on detected physical conditions of the automotive vehicle 100 and its proximity. As described in further detail below, these signals may be used by the vehicle computing system 200 to determine how to control operation of the automotive vehicle 100.

The cameras 214 are configured to capture images of the environment surrounding the automotive vehicle 100 in any aspect or field of view (FOV). The FOV may have any angle or aspect such that images of the areas ahead of, to the side, behind, above, or below the automotive vehicle 100 may be captured. In some embodiments, the FOV may be limited to particular areas around the automotive vehicle 100 (e.g., forward of the automotive vehicle 100, to the sides of the automotive vehicle 100, etc.) or may surround 360 degrees of the automotive vehicle 100. In some embodiments, the automotive vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding the automotive vehicle 100. In some embodiments, the image data generated by the cameras 214 may be sent to the vehicle computing system 200 or other aspects of the automotive vehicle 100, and this image data may include the automotive vehicle 100 or a generated representation of the automotive vehicle 100. In some embodiments, one or more systems or components of the vehicle computing system 200 may overlay labels to the features depicted in the image data, such as on a raster layer or other semantic layer of a high-definition (HD) map.

The LiDAR sensors 212 generally include a laser generator and a detector that send and receive a LiDAR signal such that LiDAR point clouds (or “LiDAR images”) of the areas in front of, to the side of, behind, above, or below the automotive vehicle 100 may be captured and represented in the LiDAR point clouds. The radar sensors 210 may include short-range RADAR (SRR), mid-range RADAR (MRR), long-range RADAR (LRR), or ground-penetrating RADAR (GPR). One or more of the sensors may emit radio waves, and a processor may process received reflected data (e.g., raw radar sensor data) from the emitted radio waves. In some embodiments, the system inputs from the cameras 214, the radar sensors 210, or the LiDAR sensors 212 may be fused or used in combination to determine conditions (e.g., locations of other objects) around the automotive vehicle 100.

The GNSS receiver 222 is positioned on the automotive vehicle 100 and may be configured to determine a location of the automotive vehicle 100, which it may embody as GNSS data, as described herein. The GNSS receiver 222 may be configured to receive one or more signals from a global navigation satellite system (e.g., Global Positioning System (GPS) constellation) to localize the automotive vehicle 100 via geolocation. In some embodiments, the GNSS receiver 222 may provide an input to or be configured to interact with, update, or otherwise utilize one or more digital maps, such as an HD map (e.g., in a raster layer or other semantic map). In some embodiments, the GNSS receiver 222 may provide direct velocity measurement via inspection of the Doppler effect on the signal carrier wave. Multiple GNSS receivers 222 may also provide direct measurements of the orientation of the automotive vehicle 100. For example, with two GNSS receivers 222, two attitude angles (e.g., roll and yaw) may be measured or determined. In some embodiments, the automotive vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about the automotive vehicle 100 and its environment.

The IMU 224 is a micro-electrical-mechanical (MEMS) device that measures and reports one or more features regarding the motion of the automotive vehicle 100, although other implementations are contemplated, such as mechanical, fiber-optic gyro (FOG), or FOG-on-chip (SiFOG) devices. The IMU 224 may measure an acceleration, angular rate, and or an orientation of the automotive vehicle 100 or one or more of its individual components using a combination of accelerometers, gyroscopes, or magnetometers. The IMU 224 may detect linear acceleration using one or more accelerometers and rotational rate using one or more gyroscopes and attitude information from one or more magnetometers. In some embodiments, the IMU 224 may be communicatively coupled to one or more other systems, for example, the GNSS receiver 222 and may provide input to and receive output from the GNSS receiver 222 such that the vehicle computing system 200 is able to determine the motive characteristics (acceleration, speed/direction, orientation/attitude, etc.) of the automotive vehicle 100.

In the example embodiment, the vehicle computing system 200 employs the vehicle interface 204 to send commands to the various aspects of the automotive vehicle 100 that control the motion of the automotive vehicle 100 (e.g., engine, throttle, steering wheel, brakes, etc.) and to receive input data from one or more of the sensors 202 (e.g., internal sensors). The external interfaces 206 are configured to enable the automotive vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, the external interfaces 206 may be configured to communicate with an external network via a wired connection 244, such as, for example, during testing of the automotive vehicle 100 or when downloading mission data after completion of a trip. The connection(s) may be used to download and install various lines of code in the form of digital files (e.g., HD maps), executable programs (e.g., navigation programs), and other computer-readable code that may be used by the automotive vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, the automotive vehicle 100 may deploy with all of the data it needs to complete a mission (e.g., perception, localization, and mission planning) and may not utilize a wireless connection or other connection while underway.

In the example embodiment, the vehicle computing system 200 is implemented by one or more processors and memory devices of the automotive vehicle 100. The vehicle computing system 200 includes modules, which may be hardware components (e.g., processors or other circuits) or software components (e.g., computer applications or processes executable by the vehicle computing system 200), configured to generate outputs, such as control signals, based on inputs received from, for example, the sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard the automotive vehicle 100.

In the example embodiment, the automotive vehicle 100 further includes a vehicle emergency alerting computing device 242. The vehicle emergency alerting computing device detects emergency conditions in the environment surrounding the automotive vehicle 100 using a machine learning model (ML model) 246. In the depicted embodiment, the vehicle emergency alerting computing device 242 is a separate computing device from the vehicle computing system 200 and coupled to the vehicle computing system 200. In some embodiments, the vehicle emergency alerting computing device 242 is a part of the vehicle computing system 200.

In the example embodiment, the vehicle emergency alerting computing device 242 receives sensor data from the sensors 202 disposed on the automotive vehicle 100. The vehicle emergency alerting computing device 242 detects an emergency condition from the sensor data. For example, the vehicle emergency alerting computing device 242 receives camera data from the camera 214 on the automotive vehicle 100 and detects the emergency condition from the camera data. In various embodiments, the detected emergency condition may be on the road or outside the road. The boundaries of emergency condition detection by the vehicle emergency alerting computing device 242 may correspond to the range of the sensor 202.

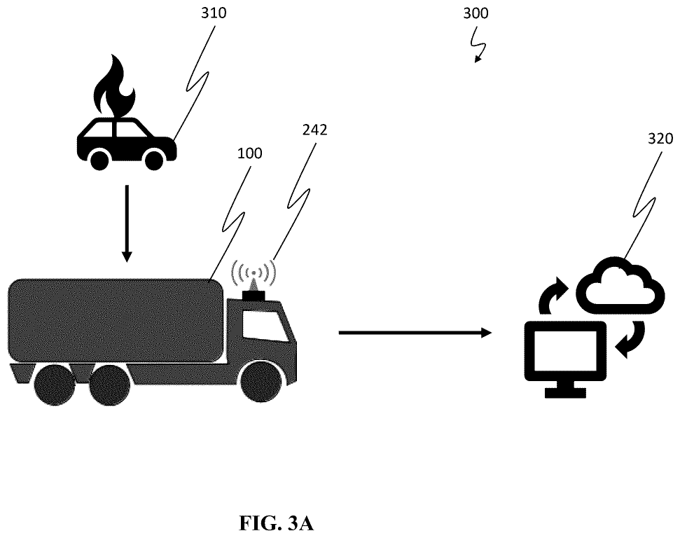

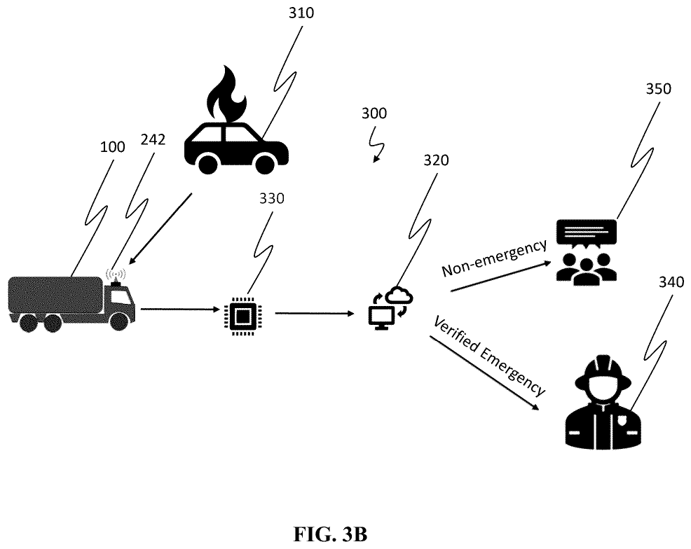

In the example embodiment, when the ML model 246 process the sensor data and detects the emergency condition, the vehicle emergency alerting computing device 242 may compute a confidence level associated with the detected emergency condition. The confidence level may correspond to a predetermined threshold to determine whether the sensor data corresponds to an emergency condition. In some embodiments, machine learning model provides the confidence level 246. When the confidence level associated with the detected emergency condition is below a threshold, the vehicle emergency alerting computing device 242 determines the detected emergency condition is a non-emergency. Alternatively, when the computed confidence level is above the threshold, the sensor data associated with the emergency condition is uploaded to a remote emergency alerting computing device 252 (see FIGS. 3A and 3B described later).

In the example embodiment, when an emergency condition is detected, the vehicle emergency alerting computing device 242 may be programmed to initiate an emergency response behavior on the automotive vehicle 100. The emergency response behavior may be associated with the emergency condition detected by the vehicle emergency alerting computing device 242. The emergency response behavior includes initiating an operation on the automotive vehicle 100 to navigate the emergency condition. In alternative embodiments, the emergency response behavior includes providing the sensor data associated with the emergency condition to the vehicle computing system 200. The vehicle computing system 242 may further evaluate the sensor data to modify the operation of the automotive vehicle 100 to navigate the emergency condition. The emergency response behavior may be determined locally on the automotive vehicle 100 based on the emergency condition detected by the vehicle emergency alerting computing device 242.

In various embodiments, the vehicle emergency alerting computing device 242 may receive updates to the ML model 246 from the remote emergency alerting computing device 320 (see FIGS. 3A and 3B described later). The update may be transmitted using a wireless network from the remote emergency alerting computing device to the automotive vehicle 100. The update from the remote emergency alerting computing device may include a retrained ML model 246. The update may also include a response based on the emergency condition response. For example, the remote emergency alerting computing device may provide a response that includes an analysis of the severity of the emergency condition. The response from the remote emergency alerting computing device may also include a determination of whether further emergency response behaviors are required for the automotive vehicle 100 to navigate the emergency condition. In various embodiments, the remote emergency alerting computing device may provide the feedback in real-time to the vehicle emergency alerting computing device 242.

In the example embodiment, the vehicle computing system 200 of the automotive vehicle 100 may provide completely autonomous (fully autonomous) or semi-autonomous operation of the automotive vehicle 100. In one example, the vehicle computing system 200 may operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

FIGS. 3A and 3B are schematic diagrams of an emergency detection and alerting system 300. FIG. 3A is a schematic diagram of example emergency detection and alerting system 300. FIG. 3B is a schematic diagram of an embodiment of the emergency detection and alerting system 300. In the example embodiment, the emergency detection and alerting system 300 includes a vehicle emergency alerting computing device 242 on the automotive vehicle 100. The vehicle emergency alerting computing device 242 includes a processor 330 programmed execute a machine learning model 246 to process sensor data captured by the automotive vehicle 100 to detect an emergency condition 310. The machine learning model 246 may be pretrained by a remote computing device, such as the remote emergency alerting device 320.

In the example embodiment, the vehicle emergency alerting computing device 242 receives sensor data from the sensors 202 on the automotive vehicle 100 that capture sensor data in the environment surrounding the automotive vehicle 100. The sensor data may include data along the road or in the environment surrounding the road of the automotive vehicle 100. For example, the vehicle emergency alerting computing device 242 processes video data from the camera 214 disposed on the automotive vehicle 100 to detect the emergency condition 310.

In the example embodiments, vehicle emergency altering computing device 242 includes the machine learning model 246, where the machine learning model 246 operates locally on the automotive vehicle 100. The machine learning model 246 is configured to detect the emergency condition 310 based on the sensor data. When an emergency condition 310 is detected, the machine learning model 246 computes a confidence level associated with the detected emergency condition 310 to determine whether to upload the sensor data to a remote emergency alerting computing device 320. The determination may correspond to a comparison of the computed confidence level to a predefined confidence level. For example, when the confidence level is at or above the predefined confidence level, the vehicle emergency alerting computing device 242 uploads the sensor data corresponding to the emergency condition 310 to the remote emergency alerting computing device 320. The vehicle emergency alerting computing device 242 is connected to the remote emergency alerting computing device 320 using a wireless connection because the remote emergency alerting computing device 320 is positioned remotely from automotive vehicle 100. When the computed confidence level is below the predefined confidence level, the vehicle emergency alerting computing device 242 does not upload the associated data to the remote emergency alerting computing device 320.

In the example embodiment, the sensor data uploaded to the remote emergency alerting computing device 320 includes the sensor data corresponding to the detected emergency condition 310 by the vehicle emergency alerting computing device 242 and/or any data associated with the response of the automotive vehicle 100 to the emergency condition 310. For example, the vehicle emergency alerting computing device 242 may upload the camera 214 sensor data corresponding to the detected emergency condition 310. Further, the control module 240 data corresponding to the response of the automotive vehicle 100 may also be uploaded.

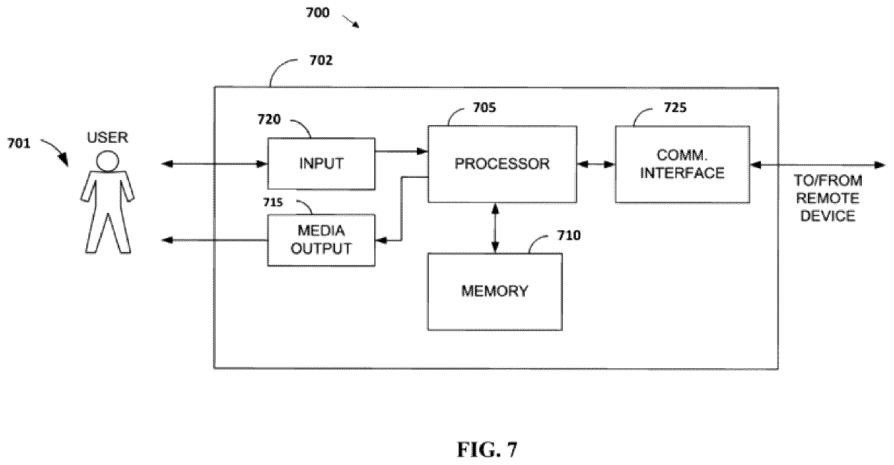

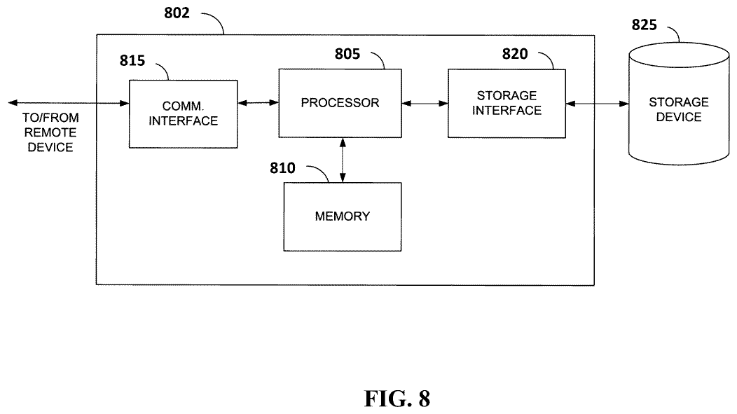

In the example embodiment, the remote emergency alerting computing device 320 may be a user computer device 702 or a server computer device 802 (shown in FIGS. 7 and 8, described later). The remote emergency alerting computing device 320 includes computing resources for further processing and analysis of the uploaded sensor data. In some embodiments, the remote emergency alerting computing device 320 may receive the sensor data corresponding to the emergency condition 310 detected by multiple automotive vehicles 100 in a fleet. The remote emergency computing device 320 may correlate the data from the multiple vehicles to a single emergency condition 310 and process the correlated data to analyze the emergency condition 310.

In some embodiments, the emergency condition 310 may be manually detected. For example, when an operator is present in the automotive vehicle 100, the operator may determine that an emergency condition 310 exists and may manually trigger the setting that the emergency condition 310 exists and the confidence level associated with the determination. The vehicle emergency alerting computing device 242 may then upload the data to the remote emergency alerting computing device 320 based on the manual detection.

In other embodiments, the vehicle emergency alerting computing device 242 also uploads data associated with a response of the automotive vehicle 100 to the emergency condition 310. The data may include vehicle computing system 200 data or an indicator that the automotive vehicle 100 was required to initiate a response to navigate the emergency condition 310. The response of the automotive vehicle 100 may include a change in speed, change in lane, or swerving depending on the determination of the vehicle computing system 200.

In the example embodiment, the remote emergency alerting computing device 320 analyzes the uploaded sensor data to verify the emergency condition 310 or determine whether the uploaded sensor data corresponds to a non-emergency. For example, the remote emergency alerting computing device 320 is further configured to assess the severity of the emergency condition based on sensor data such as image data. The ML models 246 deployed on the remote emergency alerting computing device 320 may be configured to output a severity assessment. The severity assessment includes a prediction for the level of severity of the emergency condition associated with the sensor data. The severity assessment may be used by the remote emergency alerting computing device 320 to scale the response of the verified emergency.

When the remote emergency computing device 320 verifies the emergency condition 310, the remote emergency computing device 320 initiates a response action based on the analysis of the sensor data. The remote emergency alerting computing device 320 may scale the response action based on the assessed severity of the emergency condition 310. The response action may include alerting emergency service providers 340 based on the analysis of the sensor data. For example, a disabled vehicle safely stopped on the shoulder may correspond to a low assessed severity. When the assessed severity is low, the remote emergency alerting computing device 320 may scale the response by alerting emergency service providers 340 using a non-emergency contact. Alternatively, when the assessed severity is high, the remote emergency alerting computing device 320 may scale the response by contacting multiple emergency service providers 340.

In the example embodiment, the remote emergency computing device 320 may provide information to the emergency service providers 340 related to the emergency condition 310, such as a description of the emergency condition 310 and associated location data. In some embodiments, the vehicle emergency alerting computing device 242 may upload the location data of the emergency condition 310 to the remote emergency computing device 320 used to alert the emergency service providers 340. Additionally or alternatively, the remote emergency alerting computing device 320 may provide a response action to the automotive vehicle 100. The response action may include actions for the automotive vehicle 100 to navigate the emergency condition 310.

In the example embodiment, the remote emergency alerting computing device 320 may determine the emergency condition 310 is a non-emergency. When the remote emergency computing device 320 determines that the emergency condition 310 is a non-emergency, the remote emergency alerting computing device 320 initiates a response, such as retraining the ML model 246 using the emergency condition 310 as feedback. In some embodiments, the retrained ML model 246 is used to update the ML models 246 on the vehicle emergency alerting computing devices 242. Updating the ML model 246 on the vehicle emergency alerting computing device 242 with the retrained ML model 246 improves emergency condition 310 detection. For example, the retrained ML model 246 detect emergency conditions 310 with increased accuracy or be retrained to detect additional types of emergency conditions 310.

In the example embodiment, combining the emergency detection capabilities of the vehicle emergency alerting computing device 242 with the additional computing resources of the remote emergency alerting computing device 320 provides an improved system for detecting and responding to emergency conditions 310 that improves without increasing demand on the limited computing resources on board the automotive vehicle 100.

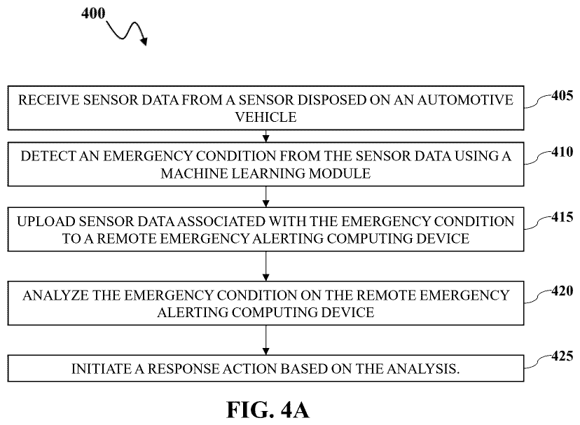

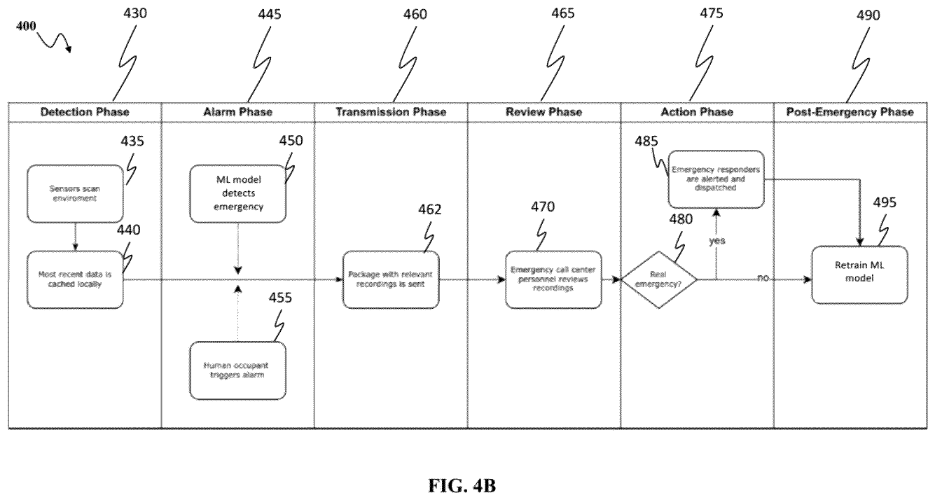

FIG. 4A is a flow chart of an example method 400 for emergency detection and alerting. The method 400 may be implemented in the emergency detection and alerting system 300 shown in FIGS. 3A and 3B. In the example embodiments, the method 400 is a computer-implemented method for processing an emergency condition. The method 400 includes receiving 405 sensor data from a sensor disposed on an automotive vehicle 100. In some embodiments, sensor data is received from each of the automotive vehicles 100 within the fleet. The method 400 further includes detecting 410 an emergency condition from the sensor data using a machine learning model, such as ML model 246. Additionally, the method 400 includes uploading 415 the sensor data associated with the emergency condition to a remote emergency alerting computing device. The method 400 also includes analyzing 420 the emergency condition on the remote emergency alerting computing device. Additionally, the method 400 includes initiating 425 a response action based on the analysis. The response action may vary based on the analysis 420 of the emergency condition. If the remote emergency alerting computing device verifies that the emergency condition is a real emergency, the response action may include alerting emergency service providers. Alternatively, if the analysis 420 of the emergency condition is determined to be a non-emergency, the response action may include retraining the machine learning model 246 using the sensor data associated with the non-emergency. The machine learning model 246 may then be updated on the vehicle emergency alerting computing devices 242 within the fleet of automotive vehicles to improve the accuracy of future detections of emergency conditions. The method 400 may include additional, fewer, or alternative steps.

In certain embodiments, the method further includes detecting the emergency conditions using a machine learning model pretrained in the remote emergency alerting computing device.

In some embodiments, the method 400 further includes determining the emergency condition as non-emergency; and retraining the machine learning model using the emergency condition as feedback.

In certain embodiments, the method 400 further includes updating the machine learning model deployed on the automotive vehicle with the retrained machine learning model.

In some embodiments, the method 400 further includes alerting emergency service providers upon a verification of the emergency condition.

In certain embodiments, the method 400 further includes uploading location data corresponding to the emergency condition; and alerting the emergency service providers with the location data.

In some embodiments, the method 400, further includes analyzing the emergency condition by assessing severity of the emergency condition. The method 400 may also include scaling the response action based on the severity when initiating the response action.

FIG. 4B is a flow chart of an example embodiment of the method 400 described in FIG. 4A. In the example embodiment, the method 400 includes a detection phase 430. The detection phase 430 includes the at least one sensor 202 scanning 435 the environment surrounding the automotive vehicle 100 to capture sensor data. In some embodiments, the most recent sensor data is cached 440 locally on the automotive vehicle 100. The cached data is processed by the vehicle emergency alerting computing device 242 in the alarm phase 445 to detect 450 the emergency condition 310. In other embodiments, the cached data is stored on the automotive vehicle 100 until the vehicle emergency alerting computing device 242 processes the sensor data and determines whether there is an emergency condition 310. The method 400 further includes an alarm phase 445. In the alarm phase, the emergency detection and alerting system 300 determines whether an emergency condition 310 is detected. The detection may be performed by a vehicle emergency alerting computing device 242. The vehicle emergency alerting computing device 242 processes the sensor data to detect the emergency condition 310. ML model 246 is used to detect 450 an emergency condition 310 based on the sensor data. An alarm may be issued when an emergency condition is detected. Additionally or alternatively, a human occupant may be in the automotive vehicle 100 to detect and/or trigger 455 the alarm corresponding to the detection of an emergency condition 310.

In the example embodiment, the method 400 further includes a transmission phase 460. Based on the detection of the emergency condition 310, the vehicle emergency alerting computing device 242 may upload the data corresponding to the emergency condition 310 to the remote emergency alerting computing device 320. For example, the camera 214 sensor data at the time of the emergency condition 310 is uploaded to the remote emergency alerting computing device 320. Additional data from the sensors 202 and the control module 240 may also be uploaded to the remote emergency alerting computing device 320. Vehicle emergency alerting computing device 242 packages 462 the relevant data corresponding to the detected emergency condition 310 for uploading to the remote emergency alerting computing device 320. For example, video data from multiple cameras 214 are stitched together to provide a panorama view of the detected emergency condition 310. In some embodiments, the uploaded data only includes the sensor data associated with the detected emergency condition 310.

In the example embodiment, the method 400 includes a review phase 465. When the remote emergency alerting computing device 320 receives the sensor data associated with the emergency condition 310, a review phase 465 is initiated. In the review phase 465, the remote emergency alerting computing device 320 analyzes the uploaded sensor data associated with the emergency condition 310 to verify the emergency condition 310. For example, the remote emergency alerting computing device 320 includes ML model 246 to verify the emergency condition 310. In some embodiments, the remote emergency alerting computing device 320 includes a sophisticated ML model or mechanism for analyzing and verifying the emergency condition 310 with increased accuracy, where the sophisticated ML model or mechanism is limited from being implemented on the automotive vehicle 100 due to the limited computing resources onboard. Additionally and/or alternatively, the emergency condition 310 and the associated sensor data are reviewed by a reviewer, such as emergency call center personnel, manually. The reviewer provides a determination of confirming or rejecting emergency condition 310. The reviewer and/or the remote emergency alerting computing device may provide confidence level of the determination.

In the example embodiment, upon review of the emergency condition, the method 400 initiates an action phase 475. Response actions in action phase 475 are initiated based on whether emergency condition 310 is a real emergency. When emergency condition 310 is confirmed to be a real emergency, the remote emergency alerting computing device 320 initiates 425 a response action for an emergency condition 310, such as alerting 485 and/or dispatching the emergency service providers. The remote emergency alerting computing device 320 processes the sensor data associated with the emergency condition 310 to determine which emergency service provider to contact. For example, the remote emergency alerting computing device 320 determines what emergency service provider to contact (e.g. ambulatory, fire, or law enforcement), and which jurisdiction is responsible for handling the emergency condition 310 (e.g. local emergency services, tribal emergency services, or federal emergency services).

In the example embodiment, the remote emergency alerting computing device 320 alerts the emergency service providers by transmitting an indicator of the emergency condition 310 to the emergency service provider. In some embodiments, the indicator includes location data corresponding to the emergency condition 310. The indicator may also include the sensor data corresponding to the emergency condition 310. Remote emergency alerting computing device 320 identifies the emergency service provider and determines the optimal mode for alerting them of the emergency condition 310 by taking into account that each emergency service provider may have distinct communication channels for handling emergency situations. For example, the remote emergency alerting computing device 320 may provide the data associated with an emergency condition 310 to a human operator to contact the emergency service provider. In other embodiments, the remote emergency alerting computing device 320 may facilitate automatic data transmission to the emergency provider through an API or automated message such as text or email by transforming the sensor data into an indicator that corresponds to the communication channel of the emergency service provider.

In the example embodiment, upon alerting 485 the emergency condition 310 or the determination of a non-emergency, the method 400 initiates the post-emergency phase 490. In the post-emergency phase 490, the ML model 246 is retrained 495 to enhance the capabilities of the ML model 246. Emergency conditions 310 rejected to be real emergency, which are false positives, are used as feedback in retraining ML model 246. False positives may also be provided as feedback to modify or fine-tune design of ML model 246. In some embodiments, the ML model 246 is retrained on the remote emergency alerting computing device 320 using all emergency conditions 310 detected by the automotive vehicle 100 and uploaded to the remote emergency alerting computing device 320. In other embodiments, either the verified emergency conditions or the non-emergency conditions are used to retrain 495 the ML model 246. For example, the uploaded sensor data and the classification of the emergency condition 310 corresponding to the sensor data as a verified emergency or a non-emergency are used to retrain the ML model 246. The retrained ML model 246 may be used to update the ML model 246 of the vehicle emergency alerting computing device 242 on the automotive vehicles 100 to improve emergency condition detection. Updates to the ML model 246 may be tested before the updated ML model 246 is deployed to the vehicle emergency alerting computing device 242. For example, the ML model 246 is tested using testing data to verify functionality and/or emergency condition detection capabilities. The remote emergency alerting computing device 320 may update the ML models 246 on the vehicle emergency alerting computing device 242 with the updated ML model 246. The update to the ML models 246 on the vehicle emergency alerting computing device 242 may be performed wirelessly upon successful testing of the retrained model. In other embodiments, the update is performed when the automotive vehicle 100 is serviced.

In some embodiments, a fleet of automotive vehicles 100 detect the emergency condition 310 and package the associated data for uploading to the remote emergency alerting computing device 320. The data associated with the detections by each of the automotive vehicles 100 within the fleet are reviewed by remote emergency computing device 320 and/or a reviewer to determine the response. The reviewed detections and/or the associated data may be used to retrain ML model 246. Using a fleet of automotive vehicles 100 increases the accuracy of detection by ML model 246 because of the increased amount of data available to retrain the ML models 246.

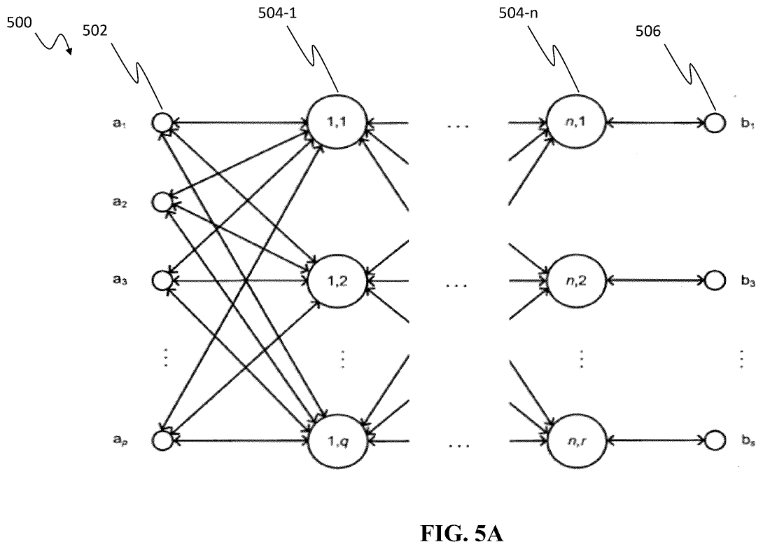

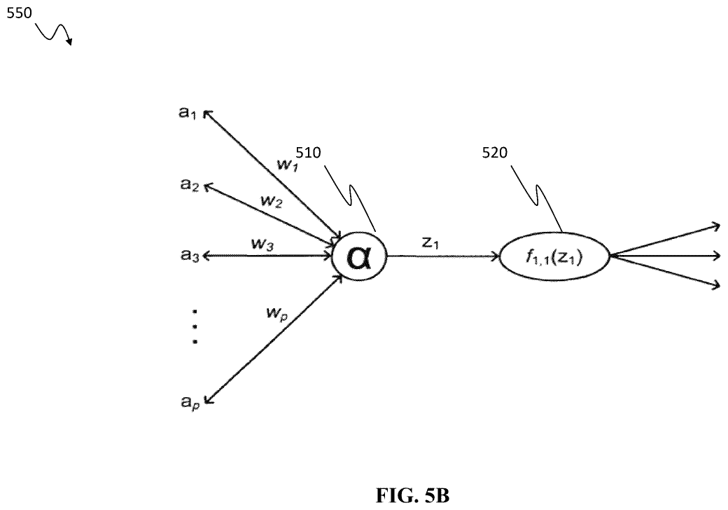

FIG. 5A depicts an example artificial neural network model 500. The artificial neural network model 500 may be implemented in the emergency detection and alerting system 242 and the method 400. The ML model 246 may include one or more neural network models 500. The example neural network model 500 includes layers of neurons 502, 504-1 to 504-n, and 506, including an input layer 502, one or more hidden layers 504-1 through 504-n, and an output layer 506. Each layer may include any number of neurons, i.e., q, r, and n in FIG. 5A may be any positive integer. It should be understood that the neural networks of a different structure and configuration from that depicted in FIG. 5A may be used to achieve the methods and systems described herein.

In the example embodiment, the input layer 502 may receive different input data. For example, the input layer 502 includes a first input a1 representing training images, a second input a2 representing patterns identified in the training images, a third input a3 representing edges of the training images, and so on. The input layer 502 may include thousands or more inputs. In some embodiments, the number of elements used by the neural network model 500 changes during the training process, and some neurons are bypassed or ignored if, for example, during execution of the neural network, they are determined to be of less relevance.

In the example embodiment, each neuron in hidden layer(s) 504-1 through 504-n processes one or more inputs from the input layer 502, and/or one or more outputs from neurons in one of the previous hidden layers, to generate a decision or output. The output layer 506 includes one or more outputs each indicating a label, confidence factor, weight describing the inputs, and/or an output image. In some embodiments, however, outputs of the neural network model 500 are obtained from a hidden layer 504-1 through 504-n in addition to, or in place of, output(s) from the output layer(s) 506.

In the example embodiment, each layer has a discrete, recognizable function with respect to input data. For example, when n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In the example embodiment, the layers are not clearly delineated in terms of the functionality they perform. For example, two or more of hidden layers 504-1 through 504-n may share decisions relating to labeling, with no single layer making an independent decision as to labeling.

FIG. 5B depicts an example embodiment of a neuron 550 that corresponds to the neuron labeled as “1,1” in hidden layer 504-1 of FIG. 5A, according to one embodiment. Each of the inputs to the neuron 550 (e.g., the inputs in the input layer 502 in FIG. 3A) is weighted such that input a1 through ap corresponds to weights w1 through wp as determined during the training process of the neural network model 500.

In the example embodiment, some inputs lack an explicit weight, or have a weight below a threshold. The weights are applied to a function α (labeled by a reference numeral 510), which may be a summation and may produce a value z1 which is input to a function 520, labeled as f1,1(z1). The function 520 is any suitable linear or non-linear function. As depicted in FIG. 3B, the function 520 produces multiple outputs, which may be provided to neuron(s) of a subsequent layer or used as an output of the neural network model 500. For example, the outputs may correspond to index values of a list of labels or may be calculated values used as inputs to subsequent functions.

It should be appreciated that the structure and function of the neural network model 500 and the neuron 550 depicted are for illustration purposes only, and that other suitable configurations exist. For example, the output of any given neuron may depend not only on values determined by past neurons, but also on future neurons.

In the example embodiment, the neural network model 504 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. The neural network model 500 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs in the example embodiment may be trained by inputting sample data sets or certain data into the programs, such as images, object statistics, and information. The machine learning programs may use deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Based upon these analyses, the neural network model 504 in the example embodiment may learn how to identify characteristics and patterns that may then be applied to analyzing image data, model data, and/or other data. For example, the model 504 may learn to identify features in a series of data points.

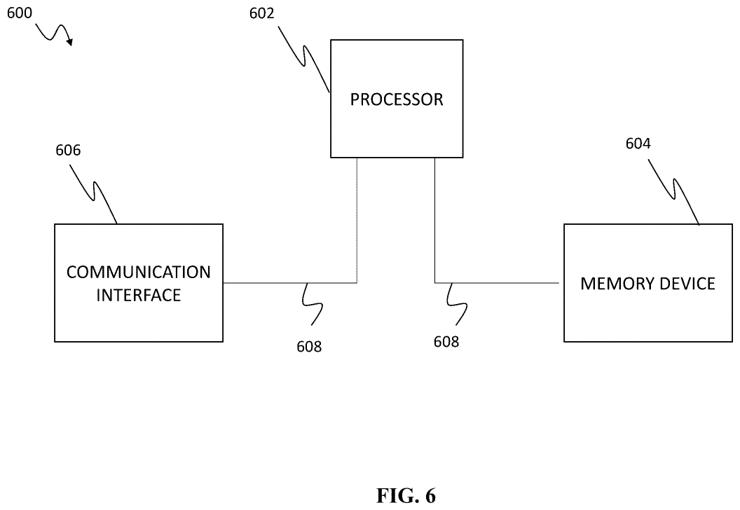

FIG. 6 is a block diagram of an example computing device 600. The vehicle computing system 200 may be implemented with one or more computing devices 600. The computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 604 includes one or more devices that enable information, such as executable instructions or other data (e.g., sensor data), to be stored and retrieved. Moreover, the memory device 604 includes one or more computer readable media, such as, without limitation, dynamic random access memory (DRAM), static random access memory (SRAM), a solid state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

FIG. 7 depicts an example configuration 700 of a user computer device 702, in accordance with one embodiment of the present disclosure. Vehicle emergency detection computing device 242 and/or remote emergency detection computing device 320 may be implemented with one or more user computer device 702(see FIGS. 3A and 3B). In the example embodiment, the user computer device 702 may be operated by a user 701. The user computer device 702 may include a processor 705 for executing instructions. In some embodiments, executable instructions may be stored in a memory area 710. The processor 705 may include one or more processing units (e.g., in a multi-core configuration). The memory area 710 may be any device allowing information such as executable instructions and/or transaction data to be stored and retrieved. The memory area 710 may include one or more computer readable media.

The user computer device 702 may also include at least one media output component 715 for presenting information to user 701. The media output component 715 may be any component capable of conveying information to the user 701. In some embodiments, the media output component 715 may include an output adapter (not shown) such as a video adapter and/or an audio adapter. The output adapter may be operatively coupled to processor 705 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, the media output component 715 may be configured to present a graphical user interface (e.g., a web browser and/or a client application) to the user 701. The graphical user interface may include, for example, an interface for viewing information provided by the emergency detection and alerting system 242 (shown in FIGS. 3A and 3B). In some embodiments, user computer device 702 may include an input device 720 for receiving input from the user 701. The user 701 may use the input device 720 to, without limitation, provide information either through speech or typing.

The input device 720 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of the media output component 715 and the input device 720.

The user computer device 702 may also include a communication interface 725, communicatively coupled to a remote device such as the remote emergency alerting computing device 320 or the vehicle emergency alerting computing device 242. The communication interface 725 may include, for example, a wired or wireless network adapter and/or a wireless data transceiver for use with a mobile telecommunications network.

Stored in the memory area 710 are, for example, computer readable instructions for providing a user interface to user 701 via media output component 715 and, optionally, receiving and processing input from the input device 720. The user interface may include, among other possibilities, a web browser and/or a client application. Web browsers enable users, such as the user 701, to display and interact with media and other information typically embedded on a web page or a website. An application may enable the user 701 to interact with, for example, the emergency detection and alerting system 300. For example, instructions may be stored by a cloud service, and the output of the execution of the instructions sent to the media output component 715.

FIG. 8 depicts an example configuration 800 of a server computer device 802, in accordance with one embodiment of the present disclosure. The remote emergency alerting computing device 320 may include one or more server computer devices 802 (see FIGS. 3A and 3B). In the example embodiment, server computer device 802 may also include a processor 805 for executing instructions. Instructions may be stored in a memory area 810. The processor 805 may include one or more processing units (e.g., in a multi-core configuration).

The processor 805 may be operatively coupled to a communication interface 815 such that the server computer device 802 is capable of communicating with a remote device such as another server computer device 802, the vehicle emergency alerting computing device 242, the remote emergency alerting computing device 320, and computer system 600, (shown in FIG. 6) (for example, using wireless communication or data transmission over one or more radio links or digital communication channels). For example, communication interface 815 may receive information from the automotive vehicle 100 (shown in FIG. 1).

Processor 805 may also be operatively coupled to a storage device 825. Storage device 825 may be any computer-operated hardware suitable for storing and/or retrieving data, such as, but not limited to, data associated with one or more of the ML models 246. In some embodiments, the storage device 825 may be integrated in the server computer device 802. For example, the server computer device 802 may include one or more hard disk drives as storage device 825.

In other embodiments, the storage device 825 may be external to the server computer device 802 and may be accessed by a plurality of server computer devices 802. For example, the storage device 825 may include a storage area network (SAN), a network attached storage (NAS) system, and/or multiple storage units such as hard disks and/or solid-state disks in a redundant array of inexpensive disks (RAID) configuration.

In some embodiments, the processor 805 may be operatively coupled to the storage device 825 via a storage interface 820. The storage interface 820 may be any component capable of providing the processor 805 with access to the storage device 825. The storage interface 820 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 805 with access to the storage device 825.

The processor 805 may execute computer-executable instructions for implementing aspects of the disclosure. In some embodiments, the processor 805 may be transformed into a special purpose microprocessor by executing computer-executable instructions or by otherwise being programmed. For example, the processor 805 may be programmed with the instruction such as illustrated herein.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) detecting emergency conditions by an automotive vehicle using a machine learning model, (b) training, retraining, and updating a ML model using a remote emergency alerting computing device, or (c) updating the machine learning model based on the emergency condition detected across the fleet of automotive vehicles.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware may be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “example” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims whether they have structural elements that do not differ from the literal language of the claims, or whether they include equivalent structural elements with insubstantial differences form the literal language of the claims.

What is claimed is:

1. An emergency alerting system for processing an emergency condition, the emergency alerting system comprising:
an automotive vehicle comprising:
at least one sensor disposed on the automotive vehicle; and
a vehicle emergency alerting computing device comprising at least one first processor in communication with at least one first memory device, the at least one first processor programmed to:
detect, using a machine learning model, an emergency condition based on sensor data of the at least one sensor, and
upload sensor data associated with the detected emergency condition to a remote emergency alerting computing device, and
the remote emergency alerting computing device comprising at least one second processor in communication with at least one second memory device, the emergency alerting computing device positioned remotely from the automotive vehicle, the at least one second processor programmed to:
receive the sensor data associated with the emergency condition,
analyze the emergency condition, and
initiate a response action based on the analysis.

2. The emergency alerting system of claim 1, wherein the at least one first processor is further programmed to:
upload the sensor data based on a confidence level output from the machine learning model.

3. The emergency alerting system of claim 1, wherein the machine learning model is pretrained in the remote emergency alerting computing device.

4. The emergency alerting system of claim 1, wherein the at least one second processor is further programmed to:
determine the emergency condition is a non-emergency; and
retrain the machine learning model using the emergency condition as feedback.

5. The emergency alerting system of claim 1, wherein the at least one first processor programmed to:
update the machine learning model with the retrained machine learning model.

6. The emergency alerting system of claim 1, wherein the at least one second processor is further programmed to alert emergency service providers upon a verification of the emergency condition.

7. The emergency alerting system of claim 6, wherein:
the at least one first processor is further programmed to:
upload the sensor data including location data of the emergency condition; and
the at least one second processor is further programmed to:
alert the emergency service providers with the location data.

8. An automotive vehicle comprising:
at least one sensor disposed on the automotive vehicle; and
a vehicle emergency alerting computing device comprising at least one processor in communication with at least one memory device, the at least one processor programmed to:
detect, using a machine learning model, an emergency condition based on sensor data from the sensor,
upload the sensor data associated with the detected emergency condition to a remote emergency alerting computing device, and
initiate a response action based on the detected emergency condition.

9. The automotive vehicle of claim 8, wherein the at least one processor is further programmed to:
upload the sensor data based on a confidence level output from the machine learning model.

10. The automotive vehicle of claim 8, wherein the machine learning model is pretrained in a remote emergency alerting computing device.

11. A computer-implemented method for processing an emergency condition, the method comprising:
receiving, by a remote emergency alerting computing device, sensor data, the sensor data associated with an emergency condition,
wherein the sensor data is acquired by at least one sensor disposed on an automotive vehicle, and
wherein the emergency condition is detected by a machine learning model deployed on the automotive vehicle;
analyzing the emergency condition on the remote emergency alerting computing device; and
initiating a response action based on the analysis.

12. The computer-implemented method of claim 11, wherein detecting the emergency condition further comprises detecting the emergency conditions using the machine learning model pretrained in the remote emergency alerting computing device.

13. The computer-implemented method of claim 11 further comprising:
determining the emergency condition is a non-emergency; and
retraining the machine learning model using the emergency condition as feedback.

14. The computer-implemented method of claim 11 further comprising updating the machine learning model deployed on the automotive vehicle with the retrained machine learning model.

15. The computer-implemented method of claim 11, wherein initiating the response action further comprises alerting emergency service providers upon a verification of the emergency condition.

16. The computer-implemented method of claim 15, wherein altering the emergency service provider further comprises:
uploading location data corresponding to the emergency condition; and
alerting the emergency service providers with the location data.

17. The computer-implemented method of claim 11, wherein a fleet includes the automotive vehicle, the method further comprising:
for each automotive vehicle in the fleet,
receiving sensor data from at least one sensor disposed on the each automotive vehicle;
detecting the emergency condition based on the sensor data using the machine learning model;
uploading the sensor data associated with the emergency condition to the remote emergency alerting computing device; and
analyzing the emergency condition on the remote emergency alerting computing device.

18. The computer-implemented method of claim 17 further comprising:
retraining the machine learning model based on analyzed emergency condition.

19. The computer-implemented method of claim 18 further comprising:
updating retrained machine learning model to the each automotive vehicle.

20. The computer-implemented method of claim 11, wherein:
analyzing the emergency condition further comprises assessing severity of the emergency condition; and
initiating the response action further comprises scaling the response action based on the severity.
